(19) United States
(12) Patent Application Publication
(10) Pub. No.: US 2011/0258526 A1
(43) Pub. Date: Oct. 20, 2011

(54) WEB CONTENT ANNOTATION MANAGEMENT WEB BROWSER PLUG-IN

(75) Inventors: TASSANEE K. SUPAKKUL, EULESS, TX (US); JANKI Y. VORA, LEWISVILLE, TX (US)

(73) Assignee: INTERNATIONAL BUSINESS MACHINES CORPORATION, ARMONK, NY (US)

(21) Appl. No.: 12/763,752

(22) Filed: Apr. 20, 2010

(51) Int. Cl. G06F 17/00; G06F 3/048

(52) U.S. Cl. 715/230; 715/234; 715/760

(57) ABSTRACT

Annotation data can be captured for at least one user-created content annotation regarding Web content presented within a Web browser by a content annotation plug-in. The content annotation plug-in can be an auxiliary software component of the Web browser. The annotation data for the at least one user-created content annotation can be stored in a data store. The data store can be a component of a computing device currently running the Web browser or a content annotation server remotely located to the computing device. A viewable aggregate of the Web content and the annotation data can be provided to at least one user-specified recipient.

### BACKGROUND

The disclosure relates to the field of Web applications and, more particularly, to a Web content annotation management Web browser plug-in.

The Internet is a powerful business tool for sharing information and documents among users, especially those who are geographically separated. Utilizing the Internet as a means of distributing Web content (i.e., text, electronic documents, images, etc.) to users requires little more than a Web browser and an Internet connection. While such an arrangement provides users with easy access to content, it does not easily support the performance of simple collaboration activities, such as capturing and managing user-made annotations regarding the Web content.

For example, a user accesses a document stored in the portable document format (PDF) from a Web site. The PDF document is presented within the Web browser using a reader plug-in component. The user wants to make some notes or annotations about the text of the PDF document. The Web browser does not include any inherent functionality to support such an activity, nor does the reader plug-in.

The user would need to capture any annotations for the PDF document using a separate mechanism, such as typing the annotations into a separate text document. Alternately, the user may have access to a PDF authoring tool that allows modification of saved PDF documents. The user would save a copy of the PDF document to their local computer and make the changes or annotations. The user is then responsible for storing and distributing the modified PDF document. The Web content, the PDF document in this case, is not immediately updated with the user's annotations, and other users are not made aware of the existence of these annotations.

While the use of online collaboration systems helps to solve these problems, the scope of an online collaboration system is limited to its internal content library and user list. That is, the features of the online collaboration system are only available for use on documents stored within the online collaboration system and by registered users.

Thus, conventional software tools and online collaboration systems do not support the average Internet user wanting to jot down notes on a product Web page to share with a friend.

### BRIEF SUMMARY

One aspect of the disclosure can include a method, a computer program product, and a system for sharing annotations for Web content. In this aspect, annotation data can be captured for at least one user-created content annotation regarding Web content presented within a Web browser by a content annotation plug-in. The content annotation plug-in can be an auxiliary software component of the Web browser. The annotation data for the at least one user-created content annotation can be stored in a data store. The data store can be a component of a computing device currently running the Web browser or a content annotation server remotely located to the computing device. A viewable aggregate of the Web content and the annotation data can be provided to at least one user-specified recipient.

Another aspect of the disclosure can include a system, method, and computer program product for capturing Web content annotations in a Web browser. In this aspect, a Web browser can present requested Web content. A set of annotation data defining the content annotations can exist for the Web browser and can be stored in a tangible storage medium. A content annotation plug-in can allow for the creation and presentation of content annotations associated the requested Web content within the Web browser. The content annotation plug-in can be an auxiliary component of the Web browser.

### BRIEF DESCRIPTION OF THE SEVERAL VIEWS OF THE DRAWINGS

FIG. 1 is a schematic diagram illustrating a system that provides a user with the ability to create and share content annotations for Web content in accordance with embodiments of the inventive arrangements disclosed herein.

FIG. 2 is a flow chart of a method describing the access of content annotations for Web content in accordance with an embodiment of the inventive arrangements disclosed herein.

FIG. 3 illustrates the use of a content annotation plug-in within a Web browser in accordance with an embodiment of the inventive arrangements disclosed herein.

FIG. 3A illustrates the user-configuration of sharing parameters for content annotations associated with Web content.

FIG. 3B illustrates the data captured within and the relationship between the annotation index and the annotation data.

### DETAILED DESCRIPTION

The disclosure discloses a solution that provides a user with a lightweight capability to create and share annotations to Web content. A content annotation plug-in can be used within a Web browser to allow a user to perform a variety of content annotation activities, such as create and save. The content annotations can be created within the display area of the Web browser as if they were part of the Web content without altering the underlying Web content. The content annotations can then be stored to a content annotation server and shared with other designated users. The content annotation server can manage storage and versioning of the annotation data corresponding to the content annotations. In one embodiment, when Web content changes, annotation data can be synchronized, thereby permitting annotations to be associated with a corresponding Web page even after the page has been updated.

As will be appreciated by one skilled in the art, aspects of the disclosure may be embodied as a system, method or computer program product. Accordingly, aspects of the disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the disclosure are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

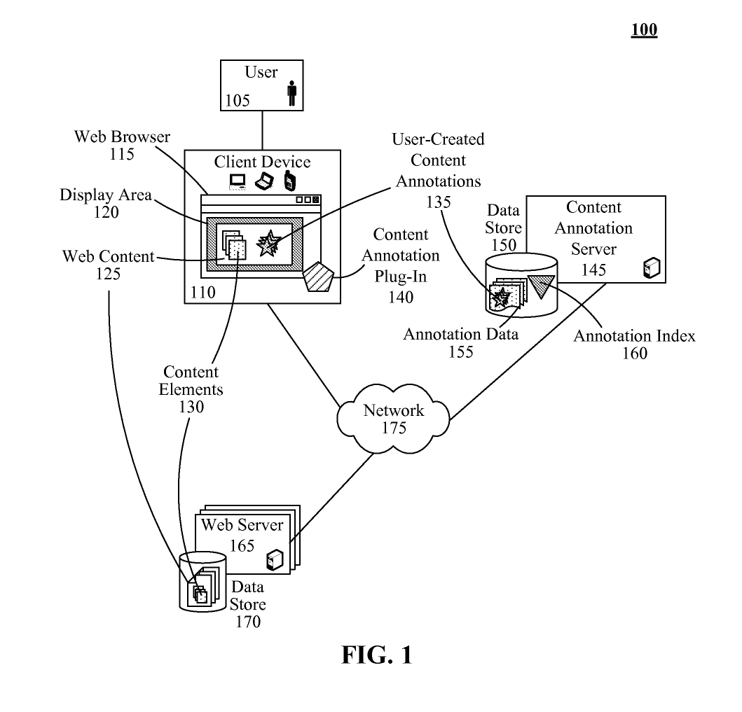

FIG. 1 is a schematic diagram illustrating a system 100 that provides a user 105 with the ability to create and share content annotations 135 for Web content 125 in accordance with embodiments of the inventive arrangements disclosed herein. In system 100, the user 105 can utilize the content annotation plug-in 140 in conjunction with a Web browser 115 to create/share/view content annotations 135 for Web content 125 accessed over the network 175.

The Web browser 115 can represent a software application installed upon the client device 110 configured to render Web content 125 within a display area 120. The Web browser 115 can communicate with a Web server 165 over the network 175 using standardized communication protocols, such as hypertext transfer protocol (HTTP), to access the requested Web content 125. The Web server 165 can correspond to the hardware and/or software components necessary to provide access to Web content 125 stored within an associated data store 170 via network 175. A Web browser 115, as used herein, is to include rich internet applications (RIAs), internet enabled desktop gadgets and widgets, and the like.

Web content 125 can represent an aggregate of one or more content elements 130 for presentation within the Web browser 115. A content element 130 can represent a logical grouping of data, such as an image, an electronic file, hyperlink, or text block. A content element 130 can be encoded using standardized formats supported by the Web browser 115, such as the hypertext markup language (HTML), extensible markup language (XML), portable document format (PDF), and the like.

Due to the wide variety of formats in which content elements 130 can be encoded, the Web browser 115 can also include the software plug-in applications necessary to present the format of a content element 130. For example, to view a content element 130 stored as a PDF file, the Web browser 115 can use a PDF reader plug-in application. As used herein, a plug-in (sometimes referred to as a plug-in, addin, add-in, addon, add-on, snap-in or snapin) is a computer program that interacts with the host (e.g., Web browser 115 to provide a certain, usually very specific, function “on demand.” By enabling a plug-in architecture, developers of browser 115 permit third-party developers to create capabilities to extend the browser 115. Thus, the browser 115 can be implemented with core functions demanded by most users, where additional functions are available as needed through various plug-ins. Use of plug-ins also enables browser 115 to support features unforeseen at the time of its creation. More specifically, system 100 includes a content annotation plug-in 140, which provides functionality to browser application 115, which the application 115 otherwise lacks. Thus, a core code base of the application 115 and standard functionality of application 115 remain unaffected by the addition of the content annotation plug-in 140.

Once the selected Web content 125 is presented within the display area 120, the user 105 can launch the content annotation plug-in 140 from the Web browser 115. The content annotation plug-in 140 can represent a software application configured to interact with the Web browser 115 to provide the user 105 with various capabilities in regards to user-created content annotations 135, herein referred to as content annotations 135. Capabilities supported by the content annotation plug-in 140 can include:
Draw function for adding a content annotation 135, modifying existing content annotation 135 content, drawing an object, underlining text, etc.
Attach function to allow the user 105 to record/attach an audio/video file or attach an electronic file.
Save Locally function to save a snapshot of the annotated Web content 125 local to the client device 110 in an offline mode for future use.
Save to Server function to save the annotated Web content 125 to the content annotation server 145. This function can also include options for creating multiple versions and replacing existing annotation data 155.
Share function to send the annotated Web content 125 to other users 105.
View function to view content annotations 135 for Web content 125, providing the user 105 has sufficient authorization.
Synchronize function to ensure annotations 155 are associated with the latest Web content 125. This function can “move” annotations 155 established with outdated Web content 125 to the most current content. One option for this function is to establish different versions of the annotations 155 to ensure a roll-back is possible and to ensure that versioned annotations can be associated with versioned Web content 125.

It should be understood that not all implementations of plug-in 140 need include all of the above capabilities, and that additional capabilities (other than the ones above, which are provided for illustrative purposes only) can be included.

As used herein, a content annotation 135 can represent a user-specified data element rendered by the content annotation plug-in 140 within the display area 120 of the Web browser 115. The content annotation 135 can overlay content elements 130 of the currently presented Web content 125. As such, storage of the content annotation 135 by the content annotation plug-in 140 can include the recording or embedding of positional information for the content annotation 135, depending on the specific implementation.

The content annotation 135 can also represent a variety of data formats that are supported by the content annotation plug-in 140, Web browser 115, and/or client device 110. For example, a first user 105 can attach an audio file as a content annotation 135. A second user 105 wanting to listen to the audio content annotation 135 made by the first user 105 would need to have an appropriate audio playback application and a listening mechanism (i.e. headphones or speakers) available for use by their client device 110.

In one embodiment, a content annotation 135 can be bound to (or can reference) a user specified element within a Web page. A content annotation 135 can also be bound to a frame, which is positioned relative to the Web page at a user-designated position. Content annotations 135 can further be generically referenced against a Web page (or other addressable resource), and can be positioned in accordance with user configurable parameters. In one embodiment, content annotations 135 can be dynamically presented as flyover windows responsive to a mouseover event being triggered for annotated content. Some visual indicia, such as a characteristic icon, highlighting, color scheme, etc. can be presented to indicate that a user established annotation exists, which can be selectively presented (e.g., via a mouseover trigger). Content annotations 135 can be indexed for searching, prioritizing, and filtering purposes. Further, content annotations 135 can be optionally secured to permit selective access to an authorized set of people, when denying access to others.

It should be emphasized that the original source of the Web content 125 is not modified in any way by the content annotation plug-in 140. The content annotations 135 can be thought of as a separate layer of information that is overlaid upon the Web content 125, preserving any content management policies internal to the source of the Web content 125.

Once the user 105 is finished creating content annotations 135 for the Web content 125, the content annotation plug-in 140 can allow the user 105 to store and share the content annotations 135 with other users 105. The content annotation plug-in 140 can be configured to store the content annotations 135 as annotation data 155 within the data store 150 of a predefined content annotation server 145.

The content annotation server 145 can represent the hardware and/or software components necessary to provide a centralized point for the storage and management of content annotations 135. The content annotation server 145 can also be configured to perform basic version and access control functions for the annotation data 155. In one embodiment, the content annotation server 145 can be a distinct physical server implemented independently of the Web server 165. In another embodiment, the functions attributed to the content annotation server 145 can be integrated with those of the Web server 165.

In addition to storing the content annotation 135, the annotation data 155 can include additional pertinent data as well as metadata about the content annotation 135. For example, the annotation data 155 can include an access control list (ACL) defined by the user 105 for sharing the content annotations 135 as well as the timestamp for when the annotation data 155 was stored.

Additionally, the annotation data 155 can include a copy of or reference to the Web content 125 and/or hosting Web server 165. Storing a copy of the Web content 125 can ensure that the content annotations 135 are presented in reference to the appropriate Web content 125. Multiple associations between different versions of Web content 125 and content annotations 135 can be established, so that a many-to-many relationship can exist between Web content 125 and the content annotations 135.

For example, the user 105 may not have control over how or when content elements 130 are modified, such as in the case of a commercial Web site. Therefore, by storing a copy of the Web content 125 as it was when the user 105 made the content annotations 135 creates a point of reference for which the content annotations 135 were made, which may not be applicable to an updated version of the Web content 125. The annotations 135 that still apply to updated Web content 125 versions can be associated or automatically linked.

The content annotation server 145 can also include an annotation index 160 to assist in managing versioning and access of annotation data 155. The annotation index 160 can contain reference information to allow the content annotation plug-in 140 to access requested annotation data 155 from the data store 150.

In another embodiment, multiple content annotation servers 145 can be used to store different pieces of annotation data 155. For example, one content annotation server 145 may store only the annotation index 160, audio and/or video content annotations 135 can be stored on another content annotation server 145, while the textual portion of the annotation data 155 is stored on a third content annotation server 145. In such an embodiment, the annotation index 160 can reside upon the content annotation server 145 acting as the central point of contact to the content annotation plug-in 140.

It should be appreciated that the content annotation plug-in 140 provides an easy-to-use mechanism for creating/sharing content annotations 135 about any accessible Web content 125 without the additional overhead incurred by conventional content management or collaboration systems. That is, the content annotation plug-in 140 provides the same functionality to the user 105 regardless of the type of Web content 125 presented.

Network 175 can include any hardware/software/and firmware necessary to convey data encoded within carrier waves. Data can be contained within analog or digital signals and conveyed through data or voice channels. Network 175 can include local components and data pathways necessary for communications to be exchanged among computing device components and between integrated device components and peripheral devices. Network 175 can also include network equipment, such as routers, data lines, hubs, and intermediary servers which together form a data network, such as the Internet. Network 175 can also include circuit-based communication components and mobile communication components, such as telephony switches, modems, cellular communication towers, and the like. Network 175 can include line based and/or wireless communication pathways.

As used herein, presented data stores 150 and 170 can be a physical or virtual storage space configured to store digital information. Data stores 150 and 170 can be physically implemented within any type of hardware including, but not limited to, a magnetic disk, an optical disk, a semiconductor memory, a digitally encoded plastic memory, a holographic memory, or any other recording medium. Data stores 150 and 170 can be a stand-alone storage unit as well as a storage unit formed from a plurality of physical devices. Additionally, information can be stored within data stores 150 and 170 in a variety of manners. For example, information can be stored within a database structure or can be stored within one or more files of a file storage system, where each file may or may not be indexed for information searching purposes. Further, data stores 150 and/or 170 can utilize one or more encryption mechanisms to protect stored information from unauthorized access.

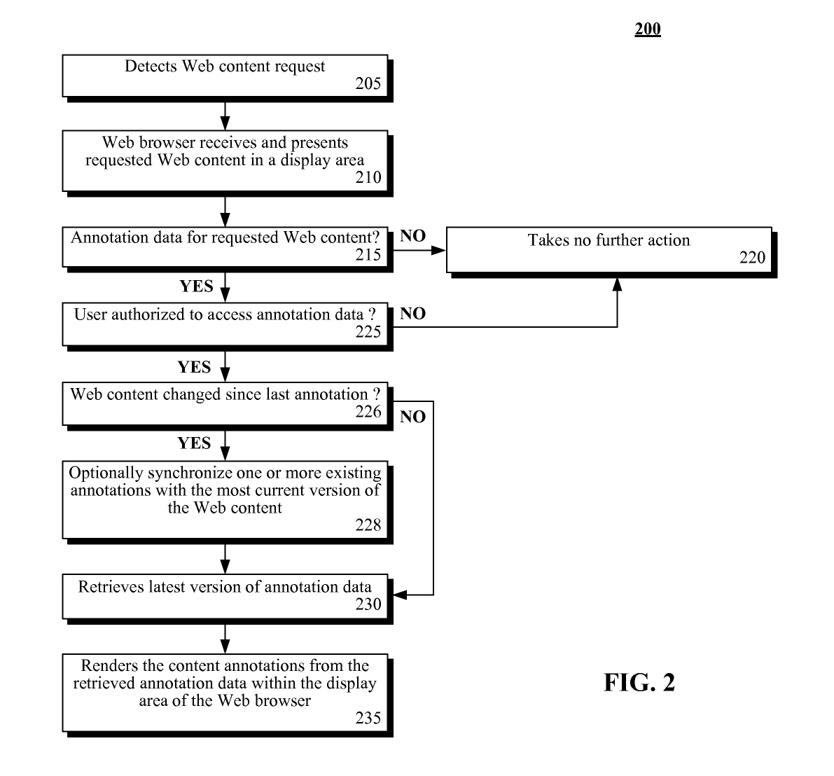

FIG. 2 is a flow chart of a method 200 describing the access of content annotations for Web content in accordance with embodiments of the inventive arrangements disclosed herein. Method 200 can be performed within the context of system 100 or any other system configured to utilize a content annotation plug-in within a Web browser to create content annotations.

Method 200 can begin in step 205 where the content annotation plug-in can detect a Web content request. The Web content request can originate from a user-command or from a software application currently-running within the Web browser. The Web browser can receive and present the requested Web content within a display area in step 210.

In step 215, the content annotation plug-in can determine if annotation data exists for the requested Web content. When annotation does not exist for the requested Web content, no further action can be taken by the content annotation plug-in in step 220. When annotation data does exist, step 225 can be performed where it can be determined if the requesting user is authorized to access the annotation data.

When the user does not have sufficient authorization to access the annotation data, flow of method 200 can proceed to step 220 where no further action is taken on the part of the content annotation plug-in. When the user is authorized to access the annotation data, a determination can be made as to whether Web content has changed since the last annotations have been made, as shown in step 226. When no changes have been made to Web content, the method 200 can progress to step 230, else to step 228. In step 228, which is an optional step, annotations can be synchronized with the most current version of the Web content. This step (step 228) can be performed through manual prompts, through a purely automated process, and/or through a semi-automated process that involves some user prompting, depending on implementation choices or configurable settings.

In step 230, the content annotation plug-in can retrieve the latest version of the annotation data. Step 230 can be expanded upon to include configurable options to allow the user to select the version of the annotation data to access, when multiple versions of the annotation data exist for which the user is authorized. In step 235, the content annotations from the retrieved annotation data can be rendered by the content annotation plug-in within the display area of the Web browser.

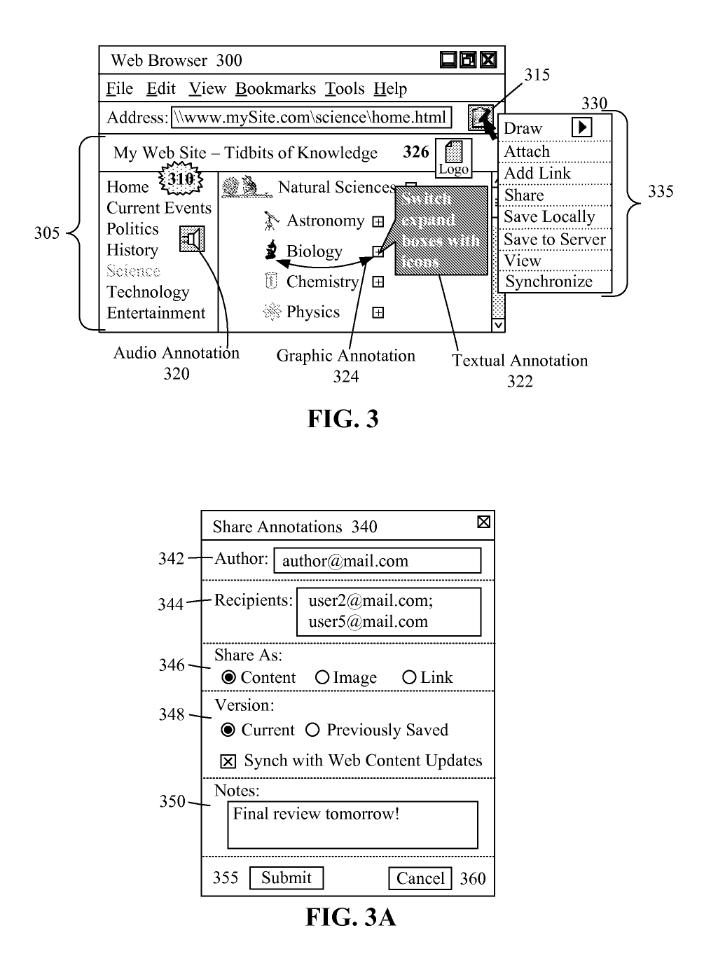

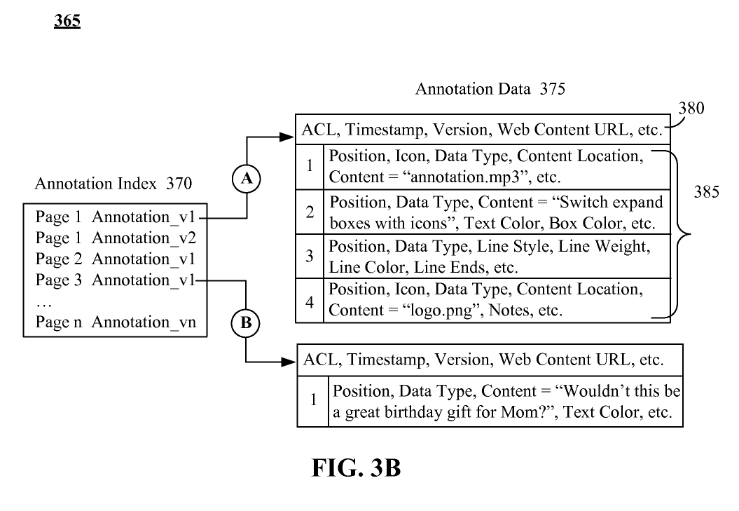

FIG. 3 illustrates the use of a content annotation plug-in within a Web browser 300 in accordance with embodiments of the inventive arrangements disclosed herein. The illustration shown in FIG. 3 can be utilized within the context of system 100 and/or in conjunction with method 200.

It is important to note that the functionality of the content annotation plug-in presented in FIGS. 3, 3A, and 3B is for illustrative purposes only, and is not intended to present a limitation of an embodiment of the disclosure.

As shown in this example, the user has accessed Web content 305 using a Web browser 300. The Web content 305 can include various content elements 310—text, frames, images, etc. Once the Web browser 300 presents the Web content 305, the content annotation plug-in can render the associated content annotations 320-326 that the user has created and/or is authorized to view.

In this example, the Web content 305 has an associated audio annotation 320, a textual annotation 322, a graphic annotation 324, and a file attachment annotation 326. The content annotation plug-in can render each content annotation 320-326 in accordance with its corresponding annotation data 375 as shown in FIG. 3B.

The content annotation plug-in can access the annotation index 370 of the associated or predefined content annotation server. From the annotation index 370, the content annotation plug-in can determine the annotation data 375 that corresponds to the content annotations 320-326 for the presented Web content 305, represented by Line A.

The annotation data 375 can include annotation metadata 380 and content annotation data 385. The annotation metadata 380 can represent high-level information that pertains to every item of content annotation data 385. Examples of annotation metadata 380 can include, but are not limited to, an access control list (ACL), a timestamp, a version identifier, a uniform resource locator (URL) for the corresponding Web content 305, and the like.

Each item of content annotation data 385 can correspond to a presented content annotation 320-326. However, the content annotation data 385 can include additional information captured by the content annotation plug-in for use in subsequent renderings of the content annotations 320-326. That is, a user sees only the text box and text of the textual annotation 322, while the content annotation data 385 for that textual annotation 322 also captures the size and color of the text box and other pieces of information required for the content annotation plug-in to “know” how to draw the textual annotation 322.

In this example, the first item of content annotation data 385 can correspond to the audio annotation 320. The content annotation data 385 can capture the position within the display area of the Web browser 300 where a designated icon is to visually appear. The data type of the content annotation 320, the location of the content (i.e. URL, URI), and the specific file can also be included.

The textual annotation 322 can be represented by the second item of content annotation data 385. In this example, the content annotation data 385 can include the position, data type, textual content, text color, box color, and so on. The graphic annotation 324 of a double arrow-headed line can correspond to the third item of content annotation data 385, while the file attachment annotation 326 can correspond to the fourth item.

While the content annotation plug-in can provide great collaborative benefits for an organization, the functions of the content annotation plug-in can also be useful for typical Web users. The content annotation data 385 represented by Line B can illustrate use of the content annotation plug-in in a more casual setting.

For example, while surfing the Internet, a user visits a Web page for a new kitchen product and thinks the product would make a good gift for his mother. The user wants to get the opinion of some of his friends about this product before purchasing. Current approaches available to the user for sharing this thought and information would require sending an electronic message (i.e., email, instant message, social network posting, etc.) to each friend containing his thoughts and a hyperlink to the product Web page. Each friend would then need to view the user's thoughts on the product separate from the product's Web page. Using the content annotation plug-in, the user could simply create a textual annotation 322 upon the Web content 305 having the text captured in the content annotation data 385 and share the aggregated content with his friends. Then, each friend would be able to see the user's thoughts in concert with the product Web page.

The functions of the content annotation plug-in can be accessed from the Web browser 300 via an annotation button 315. Selection of the annotation button 315 can present the user with an annotation menu 330 having various annotation menu items 335 representing the content annotation plug-in's functions. In this example, the annotation menu 330 can include annotation menu items to:
draw an audio annotation 320 or file logo 326;
attach a file to Web content shown in browser 300;
attach a file to a graphic 324 or textual annotation 322;
add a link to Web content shown in browser 300;
add a link to graphic annotation 324, to a file attachment logo 326, or to audio annotation 320;
share the content annotations 320-326;
save the content annotations 320-326 locally;
save the content annotations 320-326 to a content annotation server; and
view other existing content annotations 320-326 for the Web content 305.
Synchronize annotations 320-326 to updated Web content

Selection of the share annotation menu item 335 can present the user with the share annotations window 340 shown in FIG. 3A. The share annotations window 340 can provide the user with configurable sharing parameters 342-348, a notes field 350, a submit button 355, and a cancel button 360.

The sharing parameters 342-348 can represent a variety of options the user can set to influence how the content annotations 320-326 are shared with other users. In this example, the share annotations window 340 can include an author field 342, a recipients field 344, a share as designation 346, and a version selector 348.

The author field 342 can represent a text field in which the authoring user of the content annotations 320-326 can enter an email address. The email address entered in the author field 342 can be used by other users to reply to or communicate with the author.

In another embodiment, the author field 342 can be automatically populated with the user's email address when authentication to the Web content 305 or content annotations 320-326 is required and the user is currently signed onto the system.

The user can enter the email addresses of users with whom the content annotations 320-326 are to be shared with in the recipients field 344. The email addresses entered within the recipients field 344 can be stored as the ACL in the annotation metadata 380 of the annotation data 375 for the content annotations 320-326.

The share as designation 346 can allow the user to select the format in which they would like to share the annotated content with the users designated in the recipients field 344. As used herein, the term “annotated content” is defined as the aggregated presentation of the Web content 305 and the associated content annotations 320-326.

As shown in this example, the share as designation 346 can include options to share the annotated content as content, an image, or a link. The content option can embed the annotated content within an email to a designated recipient, allowing the recipient to perform supported actions (e.g., selecting to play the audio annotation 320) within the annotated content. The image option can embed an image of the annotated content within an email. While the image of the annotated content will contain the graphical icons for audio, video, and/or file attachment content annotations, the recipient cannot interact with these elements of the image.

The link option can share the annotated content as a hyperlink or URL to the location of the content annotation server, annotation index 370, or annotation data 375. However, the link option can only be utilized in the case where the annotation data 375 is stored on the content annotation server.

The version selector 348 can allow the user to select the source of the content annotations 320-326 to share. The user can choose between the content annotations 320-326 currently presented within the Web browser 300 or the annotation data 375 of content annotations 320-326 that were previously saved. Sharing of previously saved annotations can apply to annotations that were previously stored locally, as well as those stored in the server (e.g., from index 370, it could be a page 1 annotation v1 versus v2). In one embodiment, the user can create the content annotations 320-326 in an offline mode, save the content annotations 320-326 locally, and share them when online.

The version selector 348 can also selectively enable/disable the synchronization of annotations to Web content, when Web content changes. Further options (not shown) can include optional user prompting when synchronizing annotations to Web content, options to retain associations with old versions of Web content (to permit annotations to appear when using a retrieval tool such as the Way-Back-Machine that presents Web content as it existed at a designated point in time), options to match specific content items to annotations, options to show ‘orphaned annotations’ on a Web page when content items that specific associations were linked to has been removed when the Web page was updated, and the like.

The notes field 350 can provide the user with a free-form text field for adding a textual note to the email sent to the designated recipients. Selection of the submit button 355 can initiate the content annotation plug-in to share the content annotations 320-326 according to the sharing parameters 342-348. The cancel button 360 can discard the data entered into as well as close the share annotations window 340.

The flowchart and block diagrams in the Figures illustrate the architecture, functionality, and operation of possible implementations of systems, methods and computer program products according to various embodiments of the disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for sharing annotations for Web content comprising:
capturing annotation data for at least one user-created content annotation regarding Web content presented within a Web browser by a content annotation plug-in, wherein the content annotation plug-in is an auxiliary software component of said Web browser;
storing the annotation data for the at least one user-created content annotation in a data store, wherein said data store is a component of one of a computing device currently running the Web browser and a content annotation server remotely located to the computing device; and
providing a viewable aggregate of the Web content and the annotation data to at least one user-specified recipient.

2. The method of claim 1, wherein the at least one user-created content annotation comprises at least one of a textual content annotation, an audio content annotation, a video content annotation, a graphic content annotation, a file attachment annotation, and a link annotation.

3. The method of claim 1, wherein the storing of the annotation data further comprises:
recording an entry for the annotation data within an annotation index, wherein said entry provides a reference for accessing the annotation data.

4. The method of claim 1, wherein the storing of the annotation data further comprises:
extracting from the annotation data at least one item of annotation metadata for the at least one user-created content annotation, wherein said at least one item of annotation metadata represents an item of annotation data applicable to all user-created content annotations associated with the Web content.

5. The method of claim 1, wherein the capturing of annotation data for the at least one user-created content annotation further comprises:
receiving values for a plurality of annotation attributes for a user-created content annotation from a user interface presented within the Web browser, wherein said plurality of annotation attributes define an appearance of the user-created content annotation within a viewable space of the Web browser, and wherein said values are at least one of user-entered within the user interface and automatically extracted from user-performed interactions within the user interface.

6. The method of claim 1, wherein the providing of the viewable aggregate further comprises:
requesting user-definition of values for a plurality of sharing parameters, wherein said plurality of sharing parameters comprises at least a recipient list, a viewable aggregate type, and a content annotation source;
generating the viewable aggregate in accordance with a value for the viewable aggregate type;
embedding the generated viewable aggregate within an electronic message; and
conveying the electronic message containing the embedded viewable aggregate to each value comprising the recipient list.

7. The method of claim 6, wherein, when the annotation data is stored upon the content annotation server and the value for the viewable aggregate type is set as a hyperlink option, further comprising:
storing the generated viewable aggregate within the data store of the content annotation server;
determining a path location for accessing the stored viewable aggregate; and
utilizing the path location in lieu of the generated viewable aggregate within the electronic message.

8. The method of claim 1, further comprising:
uniquely referencing each captured annotation within each uniquely referenced annotation in a distinct file;
storing the distinct file comprising the annotation data along with a version number;
permitting multiple versions of the same uniquely referenced distinct file to be stored in the data store; and
providing via the content annotation plug-in a graphical user interface tool for viewing any of the stored versions of the distinct file comprising the annotation data;

9. The method of claim 1, further comprising:
permitting, via a graphical user interface using tools associated with the content annotation plug-in, the user-created content annotation to be edited or extended, wherein an edited or extended annotation is provided with a unique version number, as is the user-created content annotation; and
providing the viewable aggregate of the Web content and the annotation data along with an ability to view different versions of the aggregated data, each of the different versions corresponding to a unique version number.

10. The method of claim 1, further comprising:
detecting an update of the Web content since it has last been accessed by a user associated with the stored annotation data;
determining annotation data applicable to the updated version of the Web content;
modifying the annotation data of the data store to index the annotation data of the data store to the updated version of the Web content; and
presenting the viewable aggregate of the updated version of the Web content and the annotation data in accordance with the modifying results to the at least one user-specific recipient.

11. A system for capturing Web content annotations in a Web browser comprising:
a Web browser stored in a tangible storage medium operable to, when executed upon hardware, present requested Web content;
a tangible storage medium comprising a plurality of annotation data defining the content annotations; and
a content annotation plug-in stored in a tangible storage medium operable to, when executed upon hardware allow creation and presentation of content annotations associated the requested Web content within the Web browser, wherein said content annotation plug-in is an auxiliary component of the Web browser.

12. The system of claim 11, wherein presentation of the requested Web content within the Web browser utilizes a secondary viewing software application corresponding to a stored format of the requested Web content.

13. The system of claim 11, further comprising:
an annotation index stored in a tangible storage medium configured to provide a searchable reference for accessing the plurality of annotation data.

14. The system of claim 11, further comprising:
a content annotation server configured to provide remote storage and access to the plurality of annotation data.

15. The system of claim 11, further comprising:
an annotation index stored in a tangible storage medium configured to provide a searchable reference for accessing the plurality of annotation data, wherein the annotation index permits versioning of annotation data.

16. A computer program product comprising a computer readable storage medium having computer usable program code embodied therewith, the computer usable program code comprising:
computer usable program code being stored on a tangible storage medium, when executed by a processor being operable to capture annotation data for at least one user-created content annotation regarding Web content presented within a Web browser by a content annotation plug-in, wherein the content annotation plug-in is an auxiliary software component of said Web browser;
computer usable program code being stored on a tangible storage medium, when executed by a processor being operable to store the annotation data for the at least one user-created content annotation in a data store, wherein said data store is a component of one of a computing device currently running the Web browser and a content annotation server remotely located to the computing device; and
computer usable program code being stored on a tangible storage medium, when executed by a processor being operable to provide a viewable aggregate of the Web content and the annotation data to at least one user-specified recipient.

17. The computer program product of claim 16, further comprising:
computer usable program code being stored on a tangible storage medium, when executed by a processor being operable to record an entry for the annotation data within an annotation index, wherein said entry provides a reference for accessing the annotation data.

18. The computer program product of claim 16, further comprising:
computer usable program code being stored on a tangible storage medium, when executed by a processor being operable to extract from the annotation data at least one item of annotation metadata for the at least one user-created content annotation, wherein said at least one item of annotation metadata represents an item of annotation data applicable to all user-created content annotations associated with the Web content.

19. The computer program product of claim 16, further comprising:
computer usable program code being stored on a tangible storage medium, when executed by a processor being operable to request user-definition of values for a plurality of sharing parameters, wherein said plurality of sharing parameters comprises at least a recipient list, a viewable aggregate type, and a content annotation source;
computer usable program code being stored on a tangible storage medium, when executed by a processor being operable to generate the viewable aggregate in accordance with a value for the viewable aggregate type;
computer usable program code being stored on a tangible storage medium, when executed by a processor being operable to embed the generated viewable aggregate within an electronic message; and
computer usable program code being stored on a tangible storage medium, when executed by a processor being operable to convey the electronic message containing the embedded viewable aggregate to each value comprising the recipient list.

20. The computer program product of claim 19, wherein, when the annotation data is stored upon the content annotation server and the value for the viewable aggregate type is set as a hyperlink option, the computer program product further comprising:
computer usable program code being stored on a tangible storage medium, when executed by a processor being operable to store the generated viewable aggregate within the data store of the content annotation server;
computer usable program code being stored on a tangible storage medium, when executed by a processor being operable to determine a path location for accessing the stored viewable aggregate; and
computer usable program code being stored on a tangible storage medium, when executed by a processor being operable to utilize the path location in lieu of the generated viewable aggregate within the electronic message.
